(19) United States
(12) Patent Application Publication
(10) Pub. No.: US 2016/0123776 A1
(43) Pub. Date: May 5, 2016

(54) Sensor System

(71) Applicant: Delphi International Operations Luxembourg, S.A.R.L., Bascharage (LU)

(72) Inventor: Eric Wiethege, Bergisch Gladbach (DE)

(21) Appl. No.: 14/879,211

(22) Filed: Oct. 9, 2015

(30) Foreign Application Priority Data
Oct. 29, 2014 (EP) 14190944.0

(51) Int. Cl. G01D 5/24; B60R 16/03; B60R 16/023

(52) U.S. Cl. CPC G01D 5/24; B60R 16/023; B60R 16/03

(57) ABSTRACT

A proximity sensor system configured to interface a gate-supply with a sensor includes a sensor to detect a user, and a gate-supply to provide power to an apparatus that includes circuitry to boost power from the gate-supply for the sensor. The circuitry includes a NPN bipolar input transistor and a PNP bipolar output transistor. The base of the input transistor is connected to the input of the apparatus. The collector of the output transistor and the emitter of the input transistor are connected together to the output of the apparatus. The emitter of the output transistor is connected to a supply voltage and the collector of the input transistor is connected to the base of the output transistor.

### CROSS-REFERENCE TO RELATED APPLICATION

This application claims the benefit under 35 U.S.C. §119(a) of European Patent Application EP14190944.0, filed 29 Oct. 2014, the entire disclosure of which is hereby incorporated herein by reference.

### TECHNICAL FIELD OF INVENTION

This disclosure generally relates to a sensor system, and more particularly to a driver to control the sensor.

### BACKGROUND OF INVENTION

For Keyless Passive Entry, vehicles are usually equipped with sensors in the door handles used to detect if the user wants to open or close the car. As per example, the sensors are capacitive proximity sensors. These capacitive proximity sensors often include a small Micro Controller that detects when there is capacitance change and therefore authorizes the user to open or close the car. For cost reasons, the sensors are usually connected with two wires, one to a supply voltage and the other electrical ground. The data are sent to the connected control module via load modulation. For supplying the sensor, the control module includes a driver which is capable to supply the sensor and detect, if there is a load modulation. Usually this driver has to be switched on if the control module is in sleep mode, e.g. the vehicle is in sleep mode, capacitive sensor is active to detect if the user wanted to open the vehicle). In vehicle sleep mode, any current consumption has to be minimized not to discharge vehicles battery. Usually there is some current needed to switch on the driver. It may happen that the activation of the driver requires more current than the sensor itself in the armed state and especially the driver could use current without power consumption on the output.

Principle for the driver stage is the use of a standard Gate. There are Gates available on the market that work at greater than 16V operating voltage, which is sufficient in automotive use. These gates usually have push-pull output stages. Usually the driver strength (i.e. current capability) of such a gate is too small to drive directly a load such a capacitive sensor. The current consumption of the gate itself is very low in normal temperature range. At extreme temperatures the leakage current increases. Such a gate has several outputs and it is possible to connect several of these driver structures. To enhance the current output capability a simple emitter follower could be added. Neglecting the gate leakage current, the driver could be switched on (without a load) without additional current consumption. Depending on the gate-supply voltage, the gate output current capability has a wide variation about temperature and supply voltage. If a short circuit occurs at the output, the transistor is working in a linear range and consuming power. To survive this until the microcontroller detects that and switch off, the transistor needs much thermal capacitance. This results in “big” transistors. These kinds of Transistors have usually a small current gain. Then it could not be guaranteed to switch on this transistor in normal conditions properly.

It is an object of the invention to provide an improved sensor system that overcomes such problems.

### SUMMARY OF THE INVENTION

The present invention relates to a sensor system that enables the use of a very low power gate-supply interfaced with a sensor that may effectively reduce the current consumption of a vehicle equipped with a passive keyless entry system when the vehicle is in a standby mode, i.e. when the vehicle is parked with the engine off.

The sensor system is not limited to passive keyless entry applications; the sensor system can be used in a vehicle for any kind of functions where the detection of a part of the human body (hands, foot, fingers . . . ) is needed.

The sensor system for the vehicle is configured to interface a gate-supply with a sensor and includes the sensor to detect a user and includes the gate-supply to provide power to an apparatus. The apparatus includes an input connected to the gate-supply for receiving power from the gate-supply, a circuitry for boosting a level of the power received from the gate-supply, and an output connected to the sensor for providing the boosted level of power to the sensor. The circuitry includes a NPN bipolar transistor having a base, a collector, and an emitter. The circuitry further includes a PNP bipolar transistor having another base, another collector, and another emitter. The NPN bipolar transistor is an input transistor. The PNP bipolar transistor is the output transistor. The base of the input transistor is connected to the input of the apparatus. The collector of the output transistor and the emitter of the input transistor are connected together to the output of the apparatus. The emitter of the output transistor is connected to a supply voltage and the collector of the input transistor is connected to the base of the output transistor.

The result is that a high current gain to operate the sensor is obtained with standard small bipolar transistors.

The sensor system may further include a switch for enabling/disabling the gate-supply.

The gate-supply may include an electrical source providing power to the input of the apparatus when enabled.

The gate-supply may provide an electrical ground to the input of the apparatus when disabled.

The circuitry may further include a first series resistor connected between the base and the emitter of the input transistor, such that the output of the apparatus is connected to the electrical ground when the gate-supply is disabled.

The circuitry may further include a sensing element connected immediately in series with the collector of the output transistor, the sensing element detecting a load modulation on the output of the apparatus occurring when the sensor detects the user.

The sensor system may further include a digital converter for supervising the sensing element.

The sensing element may be a sense resistor connected immediately in series with the collector of the output transistor, the load modulation inducing a voltage variation over the sense resistor.

The circuitry may further include a second series resistor connected immediately in series with the emitter of the input transistor, the second series resistor being adapted to withstand with short circuit to ground on the output.

The circuitry may further include a third series resistor connected between the input of the apparatus and the gate-supply.

Any one of the resistors of the sensor system may be the sensing element.

The gate-supply may be a Complementary Metal Oxide Semiconductor (CMOS) gate.

The circuitry may further include a diode having an anode and a cathode, the anode being connected to the emitter of the input transistor, and the cathode being connected to the base of the input transistor.

The sensor may be a proximity sensor.

A vehicle may include the sensor system.

A door handle of the vehicle may include the sensor.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

This invention will be further described by way of non-limitative example and with reference to the accompanying drawings in which:

FIG. 1 is a schematic diagram of a proximity sensor system, in accordance with one basic example of the invention;

FIG. 2 is a schematic diagram of a proximity sensor system, in accordance with a further example of the invention;

FIG. 3 is a schematic diagram of a proximity sensor system, in accordance with another example of the invention; and

FIG. 4 is a schematic diagram of a proximity sensor system, in accordance with another further example of the invention.

### DETAILED DESCRIPTION

FIG. 1 is a schematic diagram of a proximity sensor system 10, hereafter the system 10 for a vehicle 8. The system 10 is includes a gate-supply 12, a proximity sensor, hereafter the sensor 14, an apparatus 16, a supply voltage 18, and a microcontroller 20. The apparatus 16 is connected to the supply voltage 18. The apparatus 16 includes an input 28. The gate-supply 12 is connected to the input 28 of the apparatus 16. The gate-supply 12 delivers power to the input 28 of the apparatus 16 from its electrical source (not represented). The apparatus 16 includes an output 26. The sensor 14 is connected to the output 26 of the apparatus 16. The apparatus 16 includes a circuitry 17 boosting a level of the power received from the gate-supply 12. The apparatus 16 delivers the boosted level of power to the sensor 14. The circuitry 17 includes a NPN bipolar input transistor, hereafter the input transistor 22 having a base 34, a collector 32, and an emitter 30. The circuitry 17 further includes a PNP bipolar transistor 24 having another base 39, another collector 38 and another emitter 36.

The input transistor 22 and the PNP bipolar transistor 24 is an output transistor 24. The base 34 of the input transistor is connected to the input 28 of the apparatus 16. The collector 38 of the output transistor 24 and the emitter 30 of the input transistor 22 are connected together to the output 26 of the apparatus 16. The emitter 36 of the output transistor 24 is connected to the supply voltage 18, and the collector 32 of the input transistor 22 is connected to the base 39 of the output transistor 24.

The microcontroller 20 is connected to the gate-supply 12. The microcontroller 20 has the ability to enable or to disable the gate-supply 12. When enabled by the microcontroller 20, the gate-supply 12 may provide power to the input 28 of the apparatus 16. When disabled by the microcontroller 20, the gate-supply 12 may provide an electrical ground to the input 28 of the apparatus 16. In that case, the apparatus 16 does not deliver any power to the sensor 14.

The sensor 14 can be replaced by any kind of sensor as tactile sensor or motion sensor. The system 10 may be placed in the vehicle 8 wherein a human to machine interface, such as a door handle or a center console between front occupants, is equipped with the sensor 14.

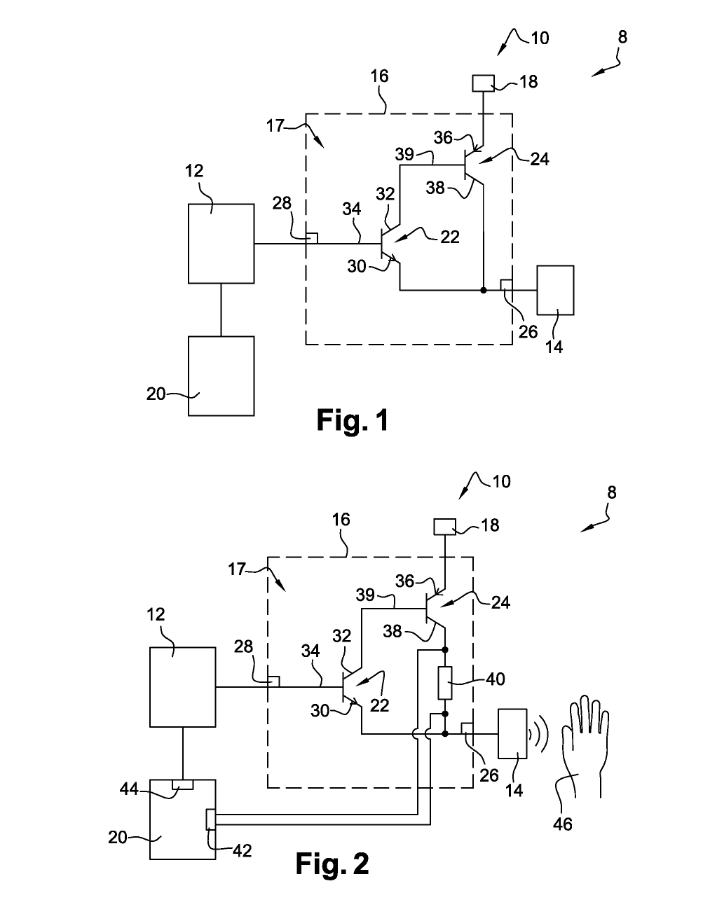

FIG. 2 illustrates another preferred embodiment of the system 10. The drawing shows similar components and reference numerals as before. The embodiment further includes a sense resistor 40, an analog to digital converter 42 and a switch 44.

The sense resistor 40 is connected immediately in series with the collector 38 of the output transistor 24. ‘Connected immediately in series’ in the sense of the electronic domain stands for the fact that there is no other electronic component between two element connected in series. One pole of the sense resistor is connected to the collector 38 of the output transistor 24. The other pole of the sense resistor 40 is the connected to the output 26 of the apparatus 16.

The analog to digital converter 42 is located inside the microcontroller 20 and it is connected to the sense resistor 40. It is connected in such a manner that it can detect a voltage variation over the sense resistor 40. It is connected in a differential manner on the two poles of the sense resistor 40.

The analog to digital converter 42 detects the voltage variation over the sense resistor 40 induced by a load modulation generated by sensor 14 excited by a hand 46 of a user.

Alternatively, the analog to digital converter 42 can detect a current variation. The analog to digital converter 42 can be also placed externally to the microcontroller 20 as long as it is connected to the microcontroller 20.

Alternatively, the means to detect a current or a voltage variation on the sense resistor can be a simple transistor, a Hall-Effect device, or other well-known solutions.

The switch 44 located inside the microcontroller 20 is connected to the gate-supply 12. It is connected in such a manner that the switch 44 of the microcontroller 20 can enable or disable the gate-supply 12. The switch 44 may be used in case a current consumption control on the system 10 is required. By disabling the gate-supply 12, the current consumption of the system 10 is reduced.

A specific technology, such as a Complementary Metal Oxide Semiconductor (CMOS) technology may be chosen for the gate-supply 12 in order to minimize the current consumption of the system 10 when it is enabled.

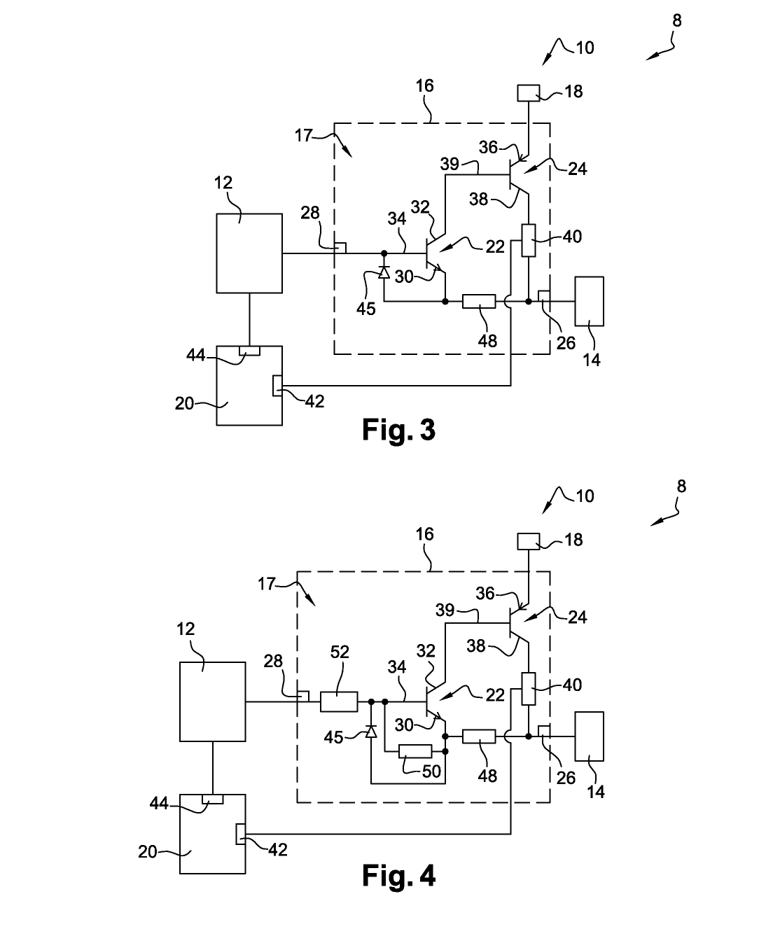

FIG. 3 illustrates a further preferred embodiment of the system 10. The drawing shows similar components and reference numerals as before. The embodiment further includes an additional resistor 48 which is a series resistor 48 placed directly in series between the emitter 30 of the input transistor 22 and the output 26 of the apparatus 16. The series resistor 48 is a part of the input transistor 22 protection against a short circuit to ground on the output 26 of the apparatus 16.

In case of a short circuit to ground (GND), the emitter 30 of the input transistor 22 is tied via the series resistor 48 to low and the current of the collector 32 of the input transistor 22 is increased. The input transistor 22 is fully conducting. The increased current of the collector 32 of the input transistor 22 forces the output transistor 24 to conduct stronger. The output PNP transistor 24 is also fully conducting. The result is that the most power is consumed at the sense resistor 40. Therefore small transistors could be used and the power consumption at the sense resistor 40 could be handled easily by choosing different sizes. The size of the sense resistor 40 depends on several factors which could be calculated easily. The person skilled in the art knows how to calculate a resistor by taking into account criteria as current, voltage, and temperature.

As an option, in order to protect the circuitry against a short circuit to the supply voltage 18, the circuitry may further includes a diode 45 having an anode and a cathode, the anode being connected to the emitter 30 of the input transistor 22, and the cathode being connected to the base 34 of the input transistor 22.

FIG. 4 illustrates a further preferred embodiment of the system 10. The drawing shows similar components and reference numerals as before. The embodiment further includes two other resistors. One of the two resistors is a NPN base emitter resistor 50 connected directly between the base 34 of the input transistor 22 and the emitter 30 of the input transistor 22. The other resistor is a NPN base resistor 52 connected directly between the input 28 of the apparatus 16 and the base 34 of the input transistor 22.

In such configuration, the apparatus works as following. The current consumption from the sensor 14 pulls the emitter 30 of the input transistor 22 down. This causes the input transistor 22 to consume current from the base 39 of the output PNP transistor 24 which starts conducting and also supplying the sensor 14. At the input transistor 22, the current of base 34 and the current of the emitter 30 are flowing to the sensor 14. At the output PNP transistor 24, the current of the collector 38 is flowing to the sensor 14 and the current of the base 39 of the output PNP transistor 24 is equal to the current of the collector 32 of the input transistor 22, which is part of the current of the emitter 30 of the input transistor 22.

The result is that the whole current is flowing to the sensor 14 itself and there is no additional current to ground for activating the proximity sensor. The formula providing the boosted current delivered by the apparatus 16 to the sensor 14 when the input 28 of the apparatus 16 is supplied by the gate-supply 12 is given by: Iproximity_sensor=Ipnp_collector+Inpn_emitter. Recognizing that Inpn_emitter=Inpn_collector+Inpn_base and Ipnp collector=Ipnp_base, then Iproximity_sensor=Ipnp_collector+Inpn_base+Inpn_collector, where Iproximity_sensor stands for the current delivered by the apparatus 16 to the sensor 14; Ipnp_collector stands for the current flowing through the collector 38 of the output PNP transistor 24; Inpn_emitter stands for the current flowing through the emitter 30 of the input transistor 22; Inpn_collector stands for the current flowing through the collector 32 of the input transistor 22; Inpn_base stands for the current flowing through the base 34 of the input transistor 22; and Ipnp_base stands for the current flowing through the base 39 of the output PNP transistor 24.

When disabled by the microcontroller 20, the gate-supply 12 may provide an electrical ground to the input 28 of the apparatus 16. In that case, the apparatus 16 does not deliver any power to the sensor 14. The gate-supply 12 provides a ground level to the input 28 of the apparatus 16.

The input transistor 22 and the output PNP transistor 24 stop conducting current. The output 26 of the apparatus 16 is pulled to ground level via the sum of resistors: the series resistor 48, the NPN bases emitter resistor 50, and the NPN base resistor 52.

Alternatively, if the input 28 of the apparatus 16 is directly connected to the base 34 of the input transistor 22, the output 26 of the apparatus 16 is also pulled to ground level via the sum of resistors: the series resistor 48 and the NPN bases emitter resistor 50.

Alternatively each individual resistor can play the role of the sense resistor 40, i.e. a detection of their voltage variation may be considered as an excitation of the sensor 14.

While this invention has been described in terms of the preferred embodiments thereof, it is not intended to be so limited, but rather only to the extent set forth in the claims that follow.

We claim:

1. A proximity sensor system for vehicles configured to interface a gate-supply with a sensor, the system comprising:
a sensor for detecting a user;
a gate-supply for providing power to an apparatus, wherein the apparatus includes
an input connected to the gate-supply for receiving power from the gate-supply;
a circuitry for providing a boosted level of power received from the gate-supply;
an output connected to the sensor for providing the boosted level of power to the sensor;
a switch for enabling/disabling the gate-supply;
a NPN bipolar input transistor having a base, a collector and an emitter;
a PNP bipolar output transistor having another base, another collector and another emitter;
the NPN bipolar input transistor is characterized as an input transistor;
the PNP bipolar transistor is characterized as an output transistor;
the base of the input transistor is connected to the input of the apparatus;
the collector of the output transistor and the emitter of the input transistor are connected together to the output of the apparatus;
the emitter of the output transistor is connected to a supply voltage; and
the collector of the input transistor is connected to the base of the output transistor.

2. The system according to claim 1, wherein the gate-supply includes an electrical source providing power to the input of the apparatus when enabled.

3. The system according to claim 1, wherein the circuitry further includes a first series resistor connected between the base and the emitter of the input transistor, such that the output of the apparatus is connected to the electrical ground when the gate-supply is disabled.

4. The system according to claim 1, wherein the circuitry further comprises a sensing element connected immediately in series with the collector of the output transistor, said sensing element detecting a load modulation on the output of the apparatus occurring when said sensor detects the user.

5. The system according to claim 4, wherein the system further comprises a digital converter for supervising the sensing element.

6. The system according to claim 4, wherein the sensing element is a sense resistor connected immediately in series with the collector of the output transistor, the load modulation inducing a voltage variation over the sense resistor.

7. The system according to claim 1, wherein the circuitry further comprises a second series resistor connected immediately in series with the emitter of the input transistor, the second series resistor being adapted to withstand with short circuit to ground on the output.

8. The system according to claim 1, wherein the circuitry further comprises a third series resistor connected between the input of the apparatus and the gate-supply.

9. The system according to claim 3, wherein any one of the resistors is the sensing element.

10. The system according to claim 1, wherein the gate-supply is a CMOS gate.

11. The system according claim 1, wherein the circuitry further comprises a diode having an anode and a cathode, said anode being connected to the emitter of the input transistor, and said cathode being connected to the base of the input transistor.

12. The system according to claim 1, wherein the sensor is a proximity sensor.

13. The system according to claim 1, wherein the system is installed in a vehicle.

14. The system according to claim 13, wherein the vehicle includes a door handle and the door handle includes the sensor.
